(19) United States
(12) Patent Application Publication
(10) Pub. No.: US 2019/0047182 A1
(43) Pub. Date: Feb. 14, 2019

(54) Methods and systems for rubber removal from vulcanization molds

(71) Applicant: Avonisys AG, Zug (CH)

(72) Inventors: Jens Guenter Gaebelein, Freienfeld / Campo di Trens (IT); Jeroen Hribar, Luzern (CH)

(21) Appl. No.: 16/059,065

(22) Filed: Aug. 9, 2018

Related U.S. Application Data
(60) Provisional application No. 62/543,953, filed on Aug. 10, 2017.

(51) Int. Cl. B29C 33/72; B08B 3/08; B08B 3/10; B08B 7/04; C08J 11/10

(52) U.S. Cl. CPC B29C 33/72; B08B 3/08; B08B 3/10; B29C 33/42; C08J 11/10; B08B 2209/005; B08B 2220/04; B08B 7/04

(57) ABSTRACT

Methods, apparatuses and systems can be provided to remove vulcanized rubber contamination and other process related residues, such as sulfur-based residues from a vulcanization mold. A vulcanization mold can be placed in a reactor where solid vulcanized rubber contamination can be turned into its base substances on a particle level by reversing the vulcanization and breaking the sulfur-bonds of the contamination. The reactor can be filled with a process liquid that interacts with the devulcanized particles. Energy can be applied to the process liquid to set it into motion to transport devulcanized particles away from the mold surface and from mold cavities such as air venting systems, of which can include then a combination of devulcanization and then a nucleation process to remove the contaminants from the mold.

This application claims priority from U.S. Provisional Patent Application Ser. No. 62/543,953, filed on Aug. 10, 2017, entitled Methods and systems for rubber removal from vulcanization molds, which applications are incorporated herein by reference in their entirety for all purposes.

### FIELD OF TECHNOLOGY

This disclosure relates generally to rubber molds, such as vulcanization molds. In one example embodiment, to an improved cleaning and removal of waste or built up contamination, such as excess vulcanized rubber inside a vulcanization mold via the use of devulcanization processes and nucleation processes, among others.

### BACKGROUND

Manufacturing of rubber parts can require the use of vulcanization molds. Such molds are applied to shape an unvulcanized piece of rubber into the desired shape while at the same time by heating up the unvulcanized material creating sulfur-crosslinks within the material. The mold itself may be made to be the negative shape of the part that may be being produced. Examples of products that require the use of vulcanization molds are for example the production of windscreen wipers as well as tires for vehicles, as well as many other fields. Vulcanization molds are subject to contamination with rubber material and other process related residues such as sulfur-based residues that adhere and perpetually build up a layer on the mold surface and to cavities, such as air evacuation cavities within the mold. The present invention applies to all types of vulcanization molds. For explanatory purposes the application of tire molds may be highlighted, but the invention may be by no means limited to tire molds.

To ensure the production of high quality tires without any relevant imperfections, the tire mold must be cleaned on a regular basis. First of all, the tire mold surface must be cleaned from time to time to remove any vulcanized rubber material and other process related residues such as sulfur-based residues that adhere and perpetually build up a layer on the mold surface. When the surface of the mold may be only moderately contaminated, such surface cleaning of the mold may be typically performed while the mold remains mounted inside the curing press. The mold may be then typically cleaned by using a CO2 or dry ice blasting technology. Alternatively, a laser surface cleaning device can be applied to selectively remove/ablate the contamination from the surface of the mold while the mold remains mounted inside the curing press.

In case the surface contamination of the tire mold may be too high and cannot be adequately removed while the mold remains mounted inside the curing press, or in case the cured tire has faulty areas caused by malfunction of certain areas of the air evacuation/air venting system due to clogging with rubber material and other process related residues such as Sulfur based residues, the mold has to be removed from the curing press and disassembled into its individual segments or components for cleaning.

During tire production, a tire mold may be typically removed from the curing press and disassembled into its individual segments for cleaning in regular intervals. A typical cleaning interval can be after each 1000 cured tires or after each 5000 tires. The interval being mainly dependent on the compound/mixture of the rubber material and its effect on the buildup of contamination on the mold and inside mold cavities, such as the air evacuation/air venting system. Today various state of the art cleaning methods for a tire mold, in particular for a mold disassembled into its individual segments can be applied.

CO2 or dry ice blasting can be used to remove contamination such as vulcanized rubber material and other process related residues such as sulfur-based residues from the surface of the mold. The cleaning effect may be based on the kinetic energy of the CO2 or dry ice hitting the surface of the mold.

In addition, the temperature difference between the mold and the CO2 or dry ice facilitates the removal of surface contamination from the mold. Thus, CO2 and/or dry ice blasting work best when the mold may be still hot, or may be heated up again. CO2 or dry ice blasting also can be used to release partly clogged mechanical vents, such as spring vents, by using the kinetic energy to release a clogged spring mechanism. CO2 or dry ice blasting however may be strongly limited for the purpose of vent cleaning due to its inability to enter the actual venting mechanism. In addition, CO2 or dry ice blasting may be unable to adequately enter into the micro air evacuation gaps of a puzzle mold or a micro slot mold. Lastly the large amount of CO2 required for mold cleaning has an adverse impact on the environment and the global CO2 emission reduction efforts.

Selective laser removal can be used to remove contamination such as vulcanized rubber material and other process related residues such as sulfur-based residues from the surface of the mold. The cleaning effect may be based on material ablation by the laser due to evaporation of the contamination layer. The contamination layer typically evaporates at a temperature range that does not affect the underlying aluminum or steel mold material. Selective laser removal may be strongly limited for the purpose of vent cleaning due to its inability to enter the actual venting mechanism. In addition, selective laser removal may be unable to adequately enter into the micro air evacuation gaps of a puzzle mold or a micro slot mold.

Sand and/or glass bead blasting can be used to remove contamination such as vulcanized rubber material and other process related residues such as sulfur-based residues from the surface of the mold. The cleaning effect may be based on the mechanical removal of the contamination by the kinetic energy of the sand or glass bead particles that are blasted onto the mold surface. There are however a few major disadvantages of sand and/or glass bead blasting. First of all, molds that contain mechanical vents such as spring vents, or molds with micro air evacuation gaps cannot be cleaned because the sand and/or glass bead particles clog the venting mechanism. Also molds that have a surface coating, such as an anti-stick coating cannot be cleaned by sand and/or glass bead blasting as the coating would be removed unwantedly. Further the mechanical impact of sand and/or glass bead blasting can over time slightly change the dimensions of the mold segments. This can be particularly critical when blasting the individual tread pieces of a puzzle mold because the residual gap between said pieces has to be within a defined narrow width to let air pass thru, but prevent any rubber from entering. When excess blasting may be applied, said residual gaps can grow over time and thus the venting function may be adversely impacted: more rubber material enters over time, which can result in large visible markings on the tire and increased risk of clogging of the air evacuation gaps.

Ultrasonic wet chemical cleaning can be used to remove contamination such as vulcanized rubber material and other process related residues such as sulfur-based residues from the surface of the mold. The cleaning effect may be based on the cavitation effect of gas bubbles in the cleaning fluid that are generated by an ultrasonic frequency generator. In addition, certain chemistry such as solvents can be added to the cleaning fluid to facilitate the removal of the surface contamination. Ultrasonic cleaning however may be limited in its ability to reach and clean narrow and/or deep structures such as mechanical vents or micro air evacuation gaps. Mechanical drilling can be applied to remove contamination such as vulcanized rubber material and other process related residues such as Sulfur based residues from the drilled venting holes of a tire mold. A disadvantage may be that the venting holes can grow bigger and bigger in size each time a cleaning may be performed and thus more and more material will enter into said hole.

In some cases, a combination of above-mentioned processes can be applied. Except for the ultrasonic wet chemical cleaning, all cleaning processes involve some form of manual labor and/or operation of the cleaning system and are subject to operator error and thus cleaning results fluctuate.

Another problem with conventional state of the art cleaning methods, may be their inability to adequately reach inside the very narrow micro gaps, typically of 0.03-0.10 mm width, such as those of an assembled puzzle mold, or a micro slot mold, or even the circular gap of a spring vent while opened and thus not being able to reliably clean such mold venting systems and removing vulcanized rubber and other process related residues such as sulfur-based residues.

Thus, despite above mentioned cleaning processes, mechanical vents, such as spring vents must be replaced regularly to avoid unpredictable malfunction of the air venting/evacuation during the tire curing process and puzzle molds must be completely disassembled into hundreds of individual parts for cleaning, resulting in strongly increased cost for cleaning.

### SUMMARY

In some embodiments, the present invention discloses methods and systems to remove vulcanized rubber contamination and other process related residues such as sulfur-based residues from a vulcanization mold. A vulcanization mold can be placed in a reactor where solid vulcanized rubber contamination can be turned into its base substances on a particle level by reversing the vulcanization and breaking the sulfur-bonds of the contamination through a variety of methods. The mold can then be exposed to a cleaning process, which can include the introduction of a process liquid which can excavate the contamination out of the mold. This can include a nucleation process and cyclic cleaning process, where the reactor can be filled with a process liquid that interacts with the devulcanized particles. Energy can be applied to the process liquid to set it into motion to transport devulcanized particles away from the mold surface and from mold cavities such as air venting systems.

Thus, the present invention provides systems, methods or apparatuses that ingeniously apply devulcanization and related processes, such as a cyclical nucleation processes, to clean vulcanization molds, of which wherein the devulcanization process by itself, as well as along with the cyclical nucleation process is unique and inventive.

### BRIEF DESCRIPTION OF THE DRAWINGS

Example embodiments are illustrated by way of example and are not limited to the figures of the accompanying drawings, in which, like references indicate similar elements.

FIG. 1 illustrates a tire mold that typically consists of multiple tread mold segments that when adjacently closed form the negative tread surface of the tire.

FIG. 2 illustrates a cross sectional view of a tire mold segment.

FIG. 3A illustrates a cross section of a tire tread mold with drilled venting holes.

FIG. 3B illustrates a cross section of a tire tread mold with mechanical vents.

FIG. 3C illustrates a cross section of a tire tread mold, in particular a tire mold that may be built as a puzzle mold.

FIG. 3D illustrates a cross section of a tire tread mold with micro slots.

FIG. 4A illustrates a cross section of a tire tread mold with drilled venting holes that may be contaminated with vulcanized rubber.

FIG. 4B illustrates a cross section of a tire tread mold with mechanical vents that may be contaminated with vulcanized rubber.

FIG. 4C illustrates a cross section of a tire tread mold, in particular a tire mold that may be built as a puzzle mold that may be contaminated with vulcanized rubber.

FIG. 4D illustrates a cross section of a tire tread mold with micro slots that may be contaminated with vulcanized rubber.

FIG. 5A illustrates a reactor for devulcanizing rubber, filled with vulcanized rubber parts. FIG. 5B illustrates a reactor for devulcanizing rubber, after a devulcanization process.

FIG. 5C illustrates a reactor for devulcanizing rubber, filled with a tire mold that may be contaminated with vulcanized rubber.

FIG. 6A illustrates a cross section of a tire mold that may be contaminated with vulcanized rubber material on its tread surface and inside the venting systems.

FIG. 6B illustrates a cross section of a tire mold that was exposed to a devulcanization process in which a surface portion of the rubber contamination was devulcanized.

FIG. 7 illustrates a reactor for performing a devulcanization process and a liquid-based particle removal process according to some embodiments.

FIG. 8A-8F illustrate a devulcanization process and liquid-based particle removal process according to some embodiments.

FIG. 9 illustrates a reactor for performing a devulcanization process and a liquid-based particle removal process according to some embodiments.

FIG. 10 illustrates a reactor for performing a devulcanization process, a liquid-based particle removal process and a drying process according to some embodiments.

FIG. 11 illustrates a flow chart for operating a vulcanization mold cleaning process according to some embodiments.

FIG. 12 illustrates a flow chart for operating a vulcanization mold cleaning and drying process according to some embodiments.

FIG. 13 illustrates a flow chart for operating a vulcanization mold cleaning and drying process according to some embodiments.

FIG. 14 illustrates a flow chart for operating a vulcanization mold cleaning and drying process according to some embodiments.

Other features of the present embodiments will be apparent from the accompanying drawings and from the detailed description that follows.

### DETAILED DESCRIPTION

Current state of the art cleaning methods for vulcanization molds typically are optimized to detach from the mold surface vulcanized rubber material and other process related residues such as sulfur-based residues that adhere and perpetually build up a layer on the mold surface. Current state of the art cleaning methods for vulcanization molds however suffer from their inability to efficiently penetrate into the air venting system of the mold for removal of vulcanized rubber material and other process related residues such as sulfur-based residues that adhere and perpetually build up a layer inside the venting system of the mold. Also current state of the art cleaning processes involve some form of manual labor and/or operation of the cleaning system and are subject to operator error and thus cleaning results fluctuate.

The present invention provides a method, apparatus and system to provide a specific cleaning of vulcanization molds. In particular to molds with small passages and interior volumes that are subject to build up of contaminants, materials and leftovers of the vulcanization process.

In an embodiment, which may be combined with any other embodiment, the present invention provides a method to breakdown, devulcanize, or depolymerize a material such as a rubber byproduct or contaminate within molds, which may be followed by an ability to clean out the materials by a nucleation process, of which may be cyclical. It is noted that the devulcanization process, applied to the molds is unique and innovative in of itself, wherein the devulcanization methods applied towards the molds as described have never been applied before this disclosure. The nucleation process, as well as other processes herein may then also be combined as well.

In short, the mold, and undesirable material in the mold, are subjected to pressure, temperature, heat, radiation and chemicals which devulcanized, depolymerizes or otherwise breaks down the rubber or material in the molds to disparate, original or other parts, such that the material may be removed. It may be noted that this can be done in multiple and repetitive steps, such that all or some of the material may be broken down. For instance, it may be noted that in some embodiments, the material may be deep within narrow cavities or volumes, so multiple cycles of the step of breaking down or devulcanizing or depolymerizing needs to be repeated, wherein to penetrate through all of the material to be removed. Therein then may also be an optional step of a cyclically cleaning or nucleation process which may aid in the removal of the processed materials. Additionally, the full cycle of the present invention can be repeated, wherein first the material may be broken down, and then removed by a cyclic or nucleation process, such that on each subsequent cycle, a deeper layer of the material may be broken down and removed.

It has been found that devulcanization may be not enough to clean the molds, since the material stays within the molds especially in narrow cavities and passages. For instance, the devulcanization only conforms the material into a powder but the powder can still get stuck. As such, the present invention provides an optional step that applies cleaning processes such as nucleation and cyclic technology to remove the containments from the molds. This combination is unique and unobvious in the arts as described in this document as we as the fact that the devulcanization method alone is unique and unobvious as applied in this document.

In a preferred embodiment, the present invention may provide a method, system or apparatus for cleaning a mold that is contaminated with a contamination material, wherein the mold is one or more molds or mold segments. This can then additionally include wherein a user places the mold inside a reactor, wherein the inner part of the reactor is isolated from the ambient environment. The mold can then be exposed to one or more processes that breaks down the contamination material and one or more processes that removes at least the contamination material that has been broken down.

It is noted that the mold can include volumes, cavities and channels which are easily, or through use, deposited with the contamination material, and that the mold can be a vulcanization mold, contaminated with vulcanization material or byproducts, such as wherein the mold is used for forming rubber parts including tires, tire segments or retreaded surfaces. These byproducts can include vulcanization residues including sulfur based residues.

In a preferred embodiment the process that breaks down the contamination material is a process including at least one of the following processes: chemical, temperature, pressure, electrical field, or radiation.

In a preferred embodiment the process that breaks down the contamination material is a process including at least: destructing sulfur-bonds in the contamination material which turns the vulcanized rubber contamination into base substances on a particle level.

In a preferred embodiment the processes that removes at least the contamination material that has been broken down includes at least filling and then evacuating the reactor with a process liquid, such that the liquid contacts the contamination material and carries at least the broken down contamination material out of the mold and reactor for removal. It is noted that the filling of the reactor includes submerging the mold, wherein there may be a layer of a gas between the process liquid and the enclosure of the reactor.

In a preferred embodiment, then the process liquid can have energy applied to it. This can include via any process including wherein the process liquid undergoes a strong vaporization reaction and leaves the surface and the cavities of the vulcanization mold with a high kinetic energy which can evacuate the last remaining particles from the mold. This can include wherein the change of pressure or volume and resulting strong vaporization can also effectively dry the mold.

In a preferred embodiment then the pressure of the gas may be decreased and increased cyclically as well as the volume, temperature or other characteristics of the liquid and entrapped gas, such that in some embodiments the entrapped gas or air space can cause the liquid to cause a nucleation process which can include decreasing and increasing the pressure or volume of a gas causing gas bubbles inside the process liquid on the mold and inside one or more volumes, cavities or channels in the mold, wherein the gas bubbles implode during each pressure or volume cycle, such that a kinetic impact on the contaminants is combined with the motion of the process liquid motion upon implosion of the gas bubbles, such that the contamination material is freed and moved into the process liquid and out of the mold.

In a preferred embodiment, the present invention may then provide wherein evacuating the process fluid wherein the evacuation brings the removed contamination material out of the mold and the reactor, such that the mold and reactor are cleaned. The user can then cyclically repeat the processes of exposing the mold to one or more processes that breaks down the contamination material and exposes the mold to one or more processes that removes at least the contamination material that has been broken down. This may be such that any number or plurality of repetitive cycles, layered contamination material that otherwise would not have been removed in a previous cycle is broken down and removed. It is then noted that the user can repeat the processes until all or sufficient amounts of the contamination material is removed from the mold.

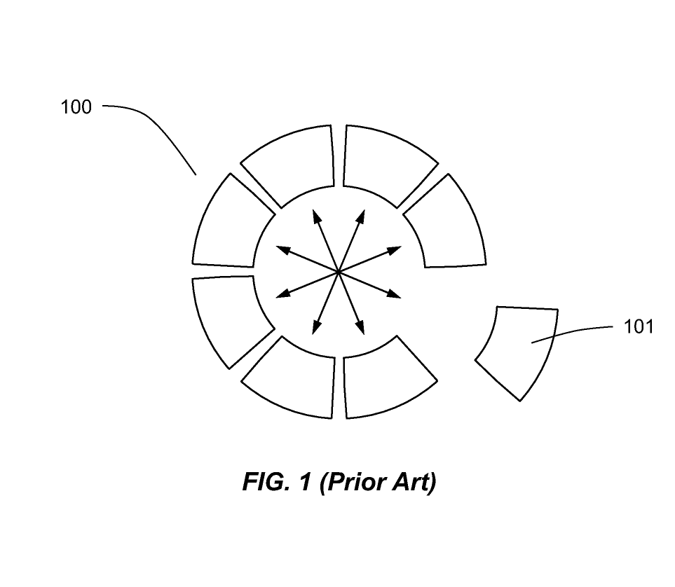

FIG. 1 (Prior Art) illustrates a mold 100. It may be noted that the figure depicts a tire mold, but it may be appreciated that the present invention relates to any vulcanizing mold. Some molds may be formed from a single piece, or may be more complex and multiple pieces depending on the application. FIG. 1, for example, shows a tire mold that typically consists of multiple mold segments 101 that when adjacently closed form the negative surface of the product such as a tire. The mold 100 also typically has 2 side plates that contain engravings such as brand name, tire dimensions and tire operation instructions. The mold segments 101 are typically mounted to a container that can contract the segments 101 after a green product may be loaded into the curing press and expand the segments 101 after the curing process may be completed to allow unloading of the cured product from the mold. A product mold 100 may be typically made from a metallic material, such as an aluminum or steel alloy, but it can be appreciated to be made of any other material, including ceramics.

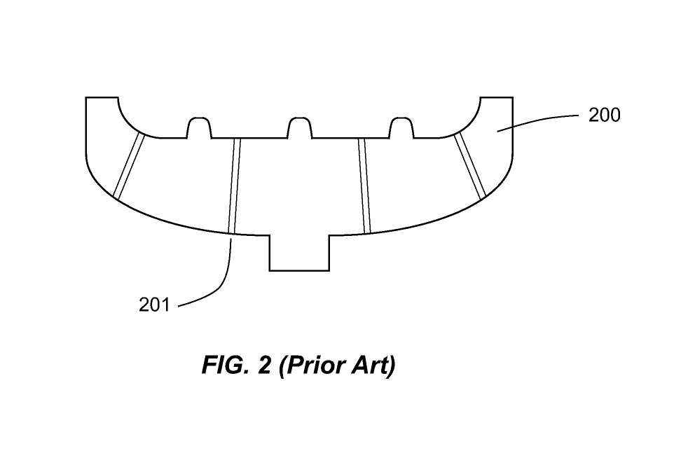

FIG. 2 (Prior Art) illustrates a cross sectional view of a mold segment 200, such that when a green product such as a tire may be loaded into the mold, the air that may be present between the green and the mold must be evacuated from the mold through air evacuation openings 201 in the mold segments to allow that the green tire can adopt the shape of the mold without any imperfections caused by air encapsulations between the green and the mold. It may be noted that the mold or mold segment 200 pictured may be a tire mold, but it may be noted that the present invention can be applied towards any mold or vulcanization mold. Of importance may be that the contamination material can be present anywhere on the mold, but especially in narrow channels or crevices, such as the pictured air channels or air evacuation openings 201 as pictured, or as one skilled in the art would suggest.

To evacuate the air from a vulcanization mold, various methods can be applied. For explanatory purposes, we review a number of prior art air evacuation methods for tire molds in particular. Again it may be noted that this review of prior art molds may be for example, and it may be stated that the method applied can be for any type of mold, mold segment, especially vulcanization molds. It is noted that the method system and apparatus for cleaning as described to these prior art structures is inventive as well as unfounded and is unobvious in any use, description or art prior to this filing.

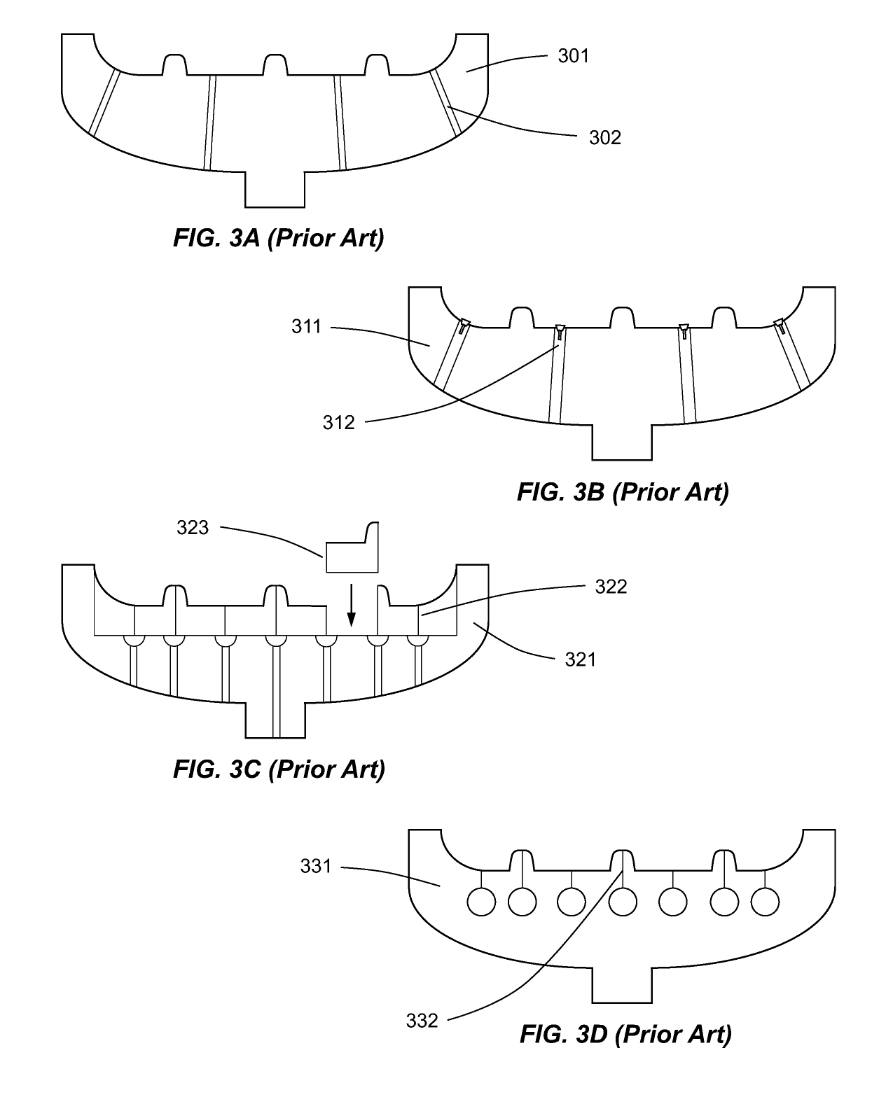

FIG. 3A (Prior Art) illustrates a cross section of a mold 301 with drilled venting holes 302, as disclosed in for example U.S. Pat. No. 4,812,281 and similar to that of FIG. 2, wherein air may be removed from the mold 301 thru drilled holes 302. Rubber material entering into these holes 302 during the curing process may be inherent to this air evacuation method and causes small hairs/whiskers on the tire. A mold 301 can contain up to several thousands of such drilled air venting holes 302.

FIG. 3B (Prior Art) illustrates a cross section of a tread mold 311 with mechanical vents 312, as disclosed in for example U.S. Pat. No. 6,923,629, wherein air may be removed from the mold 311 through a gap opening of a typically spring loaded cylindrical element and the mold surface. The spring loaded cylindrical element can be pushed down by the rubber while it adopts the shape of the mold 311 and ultimately the rubber closes that gap between the cylindrical element and the mold surface. A mold 311 can contain up to several thousands of such mechanical vent mechanisms.

FIG. 3C (Prior Art) illustrates a cross section of a mold 321, in particular a tire mold 321 that may be built as a puzzle mold, as disclosed in for example U.S. Pat. No. 5,234,326, wherein air may be removed from the mold 321 thru micro gaps 322 that remain between neighboring/consecutive tread puzzle pieces 323 that are mounted into a mold body. A mold 321 can contain up to several hundreds of such puzzle tread pieces 323.

FIG. 3D (Prior Art) illustrates a cross section of a tread mold 331 with micro slots 332, as disclosed in for example U.S. Pat. No. 9,085,114, wherein air may be removed from the mold 331 thru micro gaps 332 in the mold 331. The gap either being a cut thru slot in a solid mold insert, or a slot connected to a compression cavity or a backside cavity in a solid mold segment.

As a review for FIGS. 3A through 3D, it may be seen that the molds can include at least common or known intricate channels and volumes such as in FIG. 3A straight holes, 3B with spring vent, 3C with puzzle pieces for narrow gap and FIG. 3D with micro channels and internal expansion cavities for accepting the air. These examples are especially for applications in tire molds, but similar or other designs can be applied to the inventive method for other vulcanization or processing, such as for wipers or any other molded rubber part mold or mold segment.

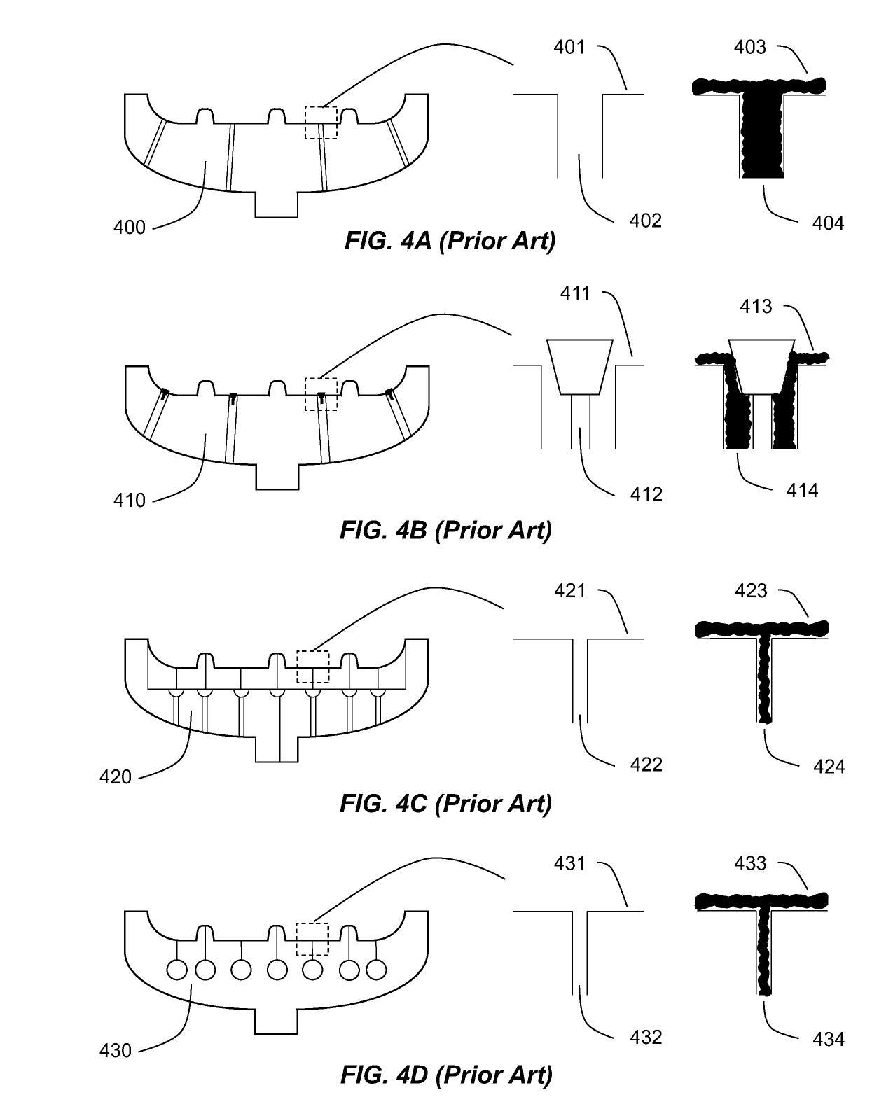

FIG. 4A-4D illustrate the buildup of contamination on the surface as well as inside the air venting system of a vulcanization mold.

In FIG. 4A a cross section of a mold such as a tire tread mold 400 with drilled venting holes 402 may be shown. During the production, the mold 400 may be contaminated perpetually, curing cycle after curing cycle. A surface layer 403 of vulcanized rubber and other process related residues such as sulfur-based residues builds up on the mold surface 401. Also the venting holes 402 over time get clogged 404 with vulcanized rubber and other process related residues such as sulfur-based residues. Air cannot properly evacuate anymore from the mold, which results in faulty products such as tire. These blockages can be complete blockages, or partial blockages and can be selective to particular channels, or may build up randomly across the mold. It may be understood that the cleaning method described will be able to remove the contamination in any case.

In FIG. 4B a cross section of a mold such as a tire tread mold 410 with mechanical vents 412 may be shown.

During the production, the mold 410 may be contaminated perpetually, curing cycle after curing cycle. A surface layer 413 of vulcanized rubber and other process related residues such as sulfur-based residues builds up on the mold surface 411. Also the mechanical vents 412 over time get clogged 414 with vulcanized rubber and other process related residues such as sulfur-based residues. The clogging causes the mechanical vents 412 to get stuck. Air cannot properly evacuate anymore from the mold, which results in faulty tires. It is noted that specifically the type of mold as seen in FIG. 4B, can be cleaned very well by the devulcanization process herein. This type of mold is very common and very expensive to maintain since it requires vent replacement for cleaning. However, a devulcanization cleaning method, system and apparatus as described in the present invention can easily clean these types of molds (as well as others). It is noted that this may be done with or without the nucleation process used in addition to the devulcanization process as applied to the molds.

In FIG. 4C a cross section of a tire tread mold 420 may be shown where air may be removed from the mold 420 thru micro gaps 422 that remain between neighboring/consecutive tread puzzle pieces. During the tire production, the mold 420 may be contaminated perpetually, curing cycle after curing cycle. A surface layer 423 of vulcanized rubber and other process related residues such as sulfur-based residues builds up on the mold surface 421. Also the micro gaps 422 over time get clogged 424 with vulcanized rubber and other process related residues such as sulfur-based residues. Air cannot properly evacuate anymore from the mold, which results in product such as faulty tires.

In FIG. 4D a cross section of a mold such as a tire tread mold 430 with micro slots 432 may be shown. During the production, the mold 430 may be contaminated perpetually, curing cycle after curing cycle. A surface layer 433 of vulcanized rubber and other process related residues such as sulfur-based residues builds up on the mold surface 431. Also the micro slots 432 over time get clogged 434 with vulcanized rubber and other process related residues such as sulfur-based residues. Air cannot properly evacuate anymore from the mold, which results in faulty product such as faulty tires.

In order to the effectively and adequately clean vulcanization molds and remove vulcanized rubber and other process related residues such as sulfur-based residues from the mold surface and from the mold venting system, in some embodiments, the present invention discloses methods and systems to turn the contamination into its base substances on a particle level by reversing the vulcanization and breaking the sulfur-bonds of the contamination. Consecutively the vulcanization mold with devulcanized contamination can be exposed to a process liquid that interacts with the devulcanized particles. Energy can be applied to the process liquid to set it into motion to transport devulcanized particles away from the mold surface and from mold cavities such as air venting systems.

The present invention in some embodiments discloses cleaning of vulcanization molds with micro slots, such as assembled puzzle molds, or micro slot molds. In some embodiments the present invention mitigates operator error by providing a cleaning process that can run in an automated manner.

In some embodiments the present invention also strongly reduces the CO2 emissions caused by cleaning of vulcanization molds, since the cleaning process includes the devulcanization process in a closed environment and since the removal of the contamination, much of which may be carbon black and other rubber precursors, may be removed in a processing fluid, of which does both reasons does not allow the contamination to be expelled into the ambient environment.

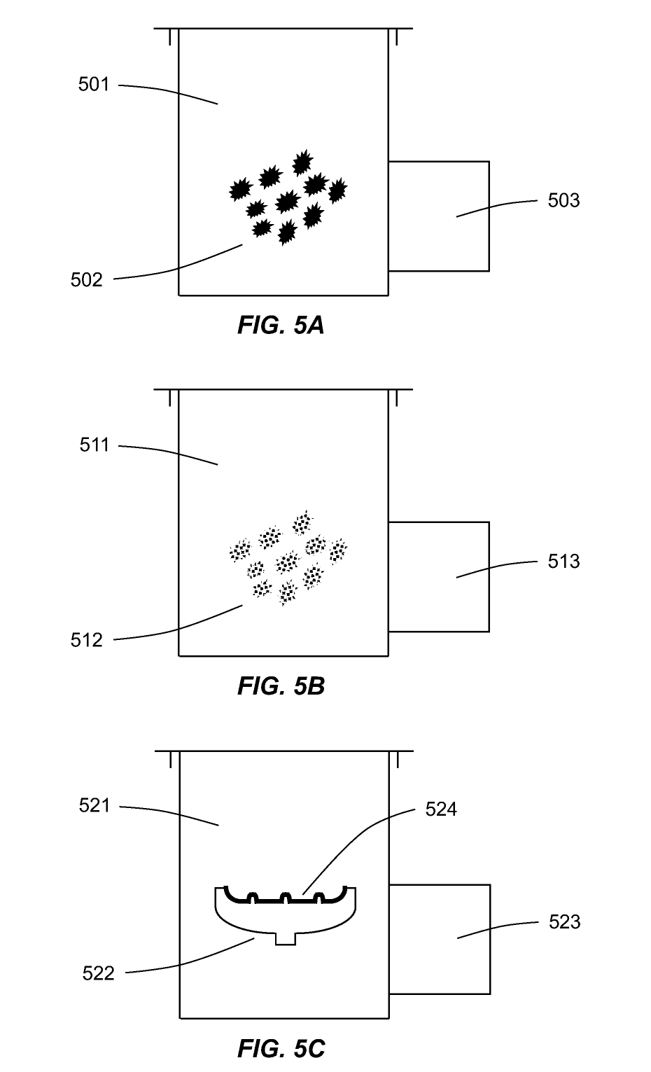

FIG. 5A illustrates a reactor 501 for devulcanizing rubber, filled with vulcanized rubber parts 502. The reactor 501 incorporates a devulcanization process unit 503. State of the art devulcanization processes are typically applied to recycle rubber material. While not obvious to apply these devulcanization process with the further cleaning, as described in the cleaning method herein this application, it can be seen that the vulcanization method used can be similar to European patent 2547702 which discloses a devulcanization method in which vulcanized rubber granulate may be mixed with a lubrication substance, the mixture being provided to a thermo-kinetic mixing device for generating a temperature sufficient to devulcanize the material and a cooling method to allow filtration of the different devulcanized substances until ultimately regenerated rubber granulate can be reclaimed. European Patent Applications 2796491 and 3088455 as well as Dutch patent 2009888 disclose a devulcanization method in which a devulcanization agent may be used for selective destruction of the sulfide bonds of a sulfur-cured rubber while applying a certain temperature to allow a devulcanization process. European patent application 2993217 and U.S. Pat. No. 8,470,897 disclose a process for devulcanization of cross-linked elastomer particles by placing the particles between two electrodes and applying an alternating electrical field having a certain frequency and having a certain voltage. US Patent Application 2015005400 discloses a process in which a vulcanized rubber may be exposed to a photoactive substance that upon exposure to a certain rubber-penetrating radiation wavelength initiates a scission of the intermolecular crosslinks in the vulcanized rubber elastomers. International patent application WO2004094513 discloses a method to reduce a vulcanized tire including a synthetic rubber by heating the rubber material and introducing a solvent. Through applying a temperature and a pressure the tire material can be devulcanized. Further the individual devulcanized substances such as carbon black are separated from a reaction product.

FIG. 5B illustrates a reactor 511 for devulcanizing rubber. The reactor 511 incorporates a devulcanization process unit 513. After the devulcanization process, the reactor contains the individual devulcanized particles 512 which can be recycled/re-used.

The present invention discloses methods for cleaning of vulcanization molds that are contaminated with vulcanized rubber material and other process related residues such as sulfur-based residues and other byproducts of vulcanization or used of the mold. These contaminants can be cleaned by exposing the vulcanization mold to a devulcanization process or via another process to break down the rubber or material components to a previous state or a state that facilitates the removal of the contaminants or byproducts.

FIG. 5C illustrates a reactor 521 for devulcanizing rubber. The reactor 521 incorporates a devulcanization process unit 523. A vulcanization mold, which can be a tire vulcanization mold 522 that may be contaminated 524 with vulcanized rubber material and other process related residues, such as sulfur-based residues may be placed inside the reactor.

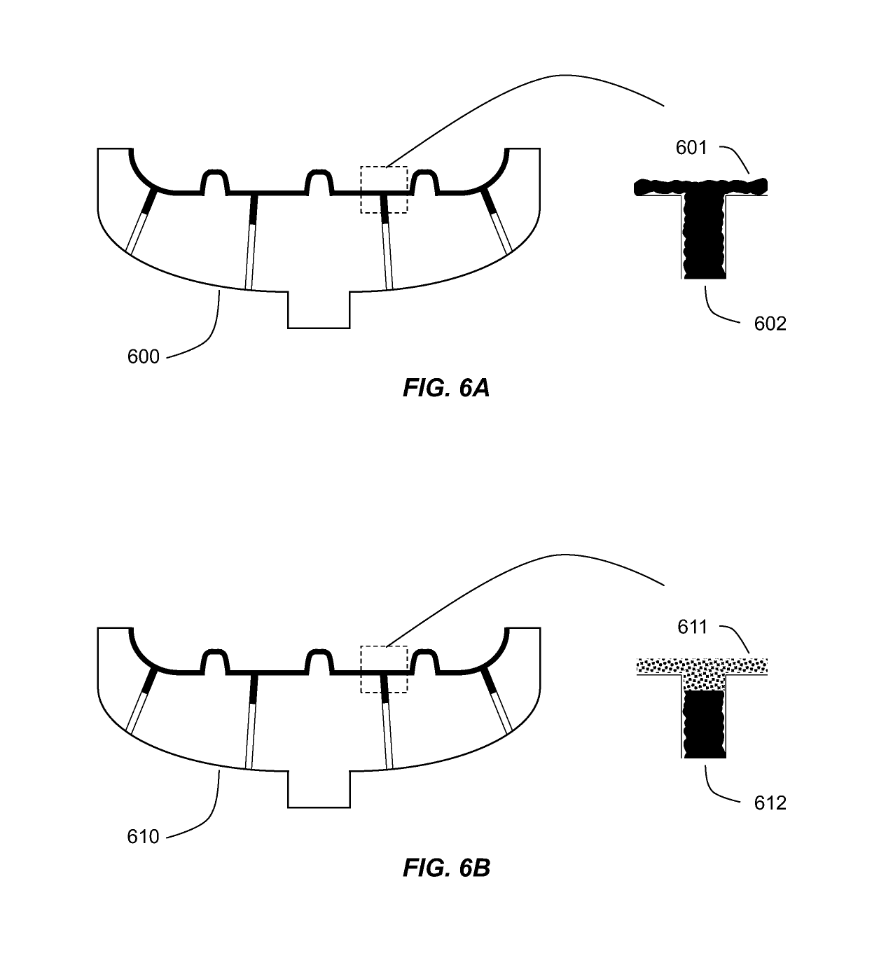

FIG. 6A illustrates a cross section of a contaminated tire mold 600, which contains both a surface contamination 601 as well as a contamination of the air venting system 602. It may be again noted that the areas with contaminants can be of any size type or function, and may include small volumes and channels for air, among others.

FIG. 6B illustrates a cross section of a contaminated mold 610, which may be exposed to a devulcanization process. The devulcanization process turns the contamination into its base substances on a particle level by reversing the vulcanization and breaking the sulfur-bonds of the contamination. A devulcanization process, in particular one of a chemical, one of a temperature, one of a pressure, one of an electrical field, or one of a radiation induced process can be applied to detach a contamination layer from a surface by disintegrating the vulcanized contamination on a particle level. Such surface particles 611 can then be removed by a consecutive cleaning step, such as a pressure washer or an ultrasonic cleaning device. Devulcanization processes however can cope with difficulties to devulcanize contamination within cavities 612 such as venting mechanisms in a mold. This can be because such cavities are up to several centimeters deep. This can be because such cavities can be very narrow, such as 0.03 to 0.10 mm wide. This can also be because contamination material on top of such cavities and prevents the contamination inside these cavities from sufficient exposure to a devulcanization process.

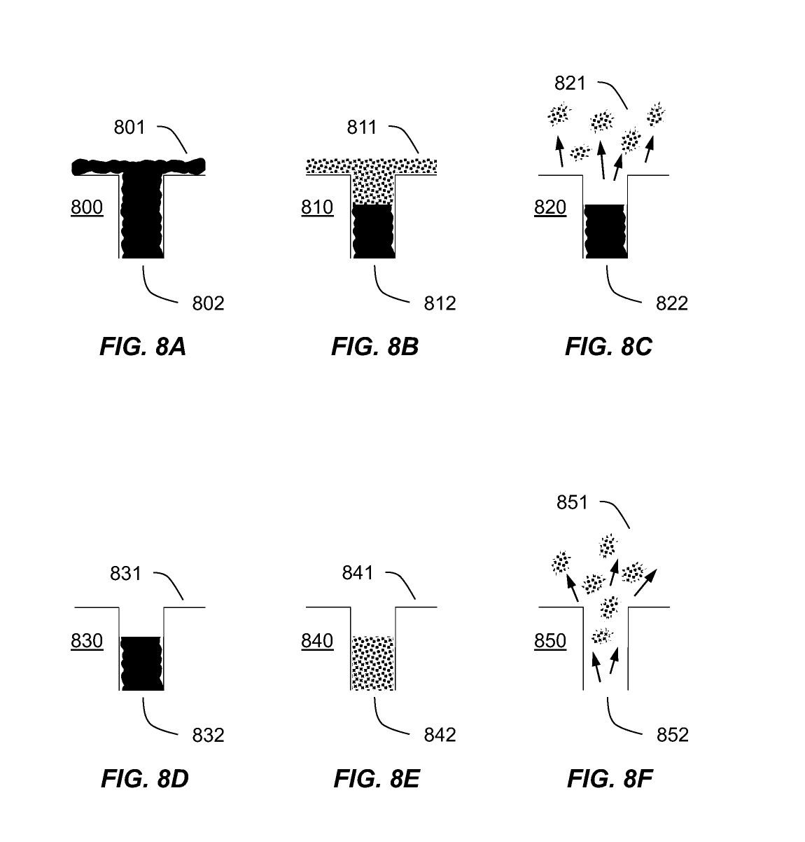

It may be noted that these devulcanization processes, as described for instance in FIG. 8, can be repeated, additionally with any number of repetitions and can be combined with a removal process or processes, such as flushing or cyclical flushing. This can include a nucleation process. This cyclical or repetitive process can be performed because the devulcanization or breakdown process may be not able to in one step penetrate through all of the material or contaminants, whether due to buildup or lockage of channels or volumes in the mold. It may be noted that thus, a cyclical or repetitive process can be used to step by step devulcanize or breakdown contaminants, and then remove and repeat to penetrate to all of the vulcanized or stuck material in the mold. It may be noted that this process may also be limited by the removal method, wherein the devulcanization or breakdown process may be able to breakdown all of the material, but upon removal the material get stuck such that a further cycle of either or both devulcanization and breakdown, or removal may be required or fruitful.

It may be also noted that the devulcanization may bring the material within the molds to a state that may be similar to when the material was introduced to the mold, such that the material can be removed by a process such as a chemical or other process as mentioned. This state can be similar to a powder, such as carbon black, which can easily be removed, but also may clog or otherwise be stuck, of which the cyclical flushing and other abilities mentioned can fully remove the pieces. This can especially be true of clogging in small volumes and channels such as a venting system in the mold, however the present invention overcomes this as mentioned. In some embodiments of the present invention, methods and systems are disclosed that enable cleaning of vulcanization molds, for example of tire molds, by exposing such molds to a devulcanization process and to a liquid-based particle removal process.

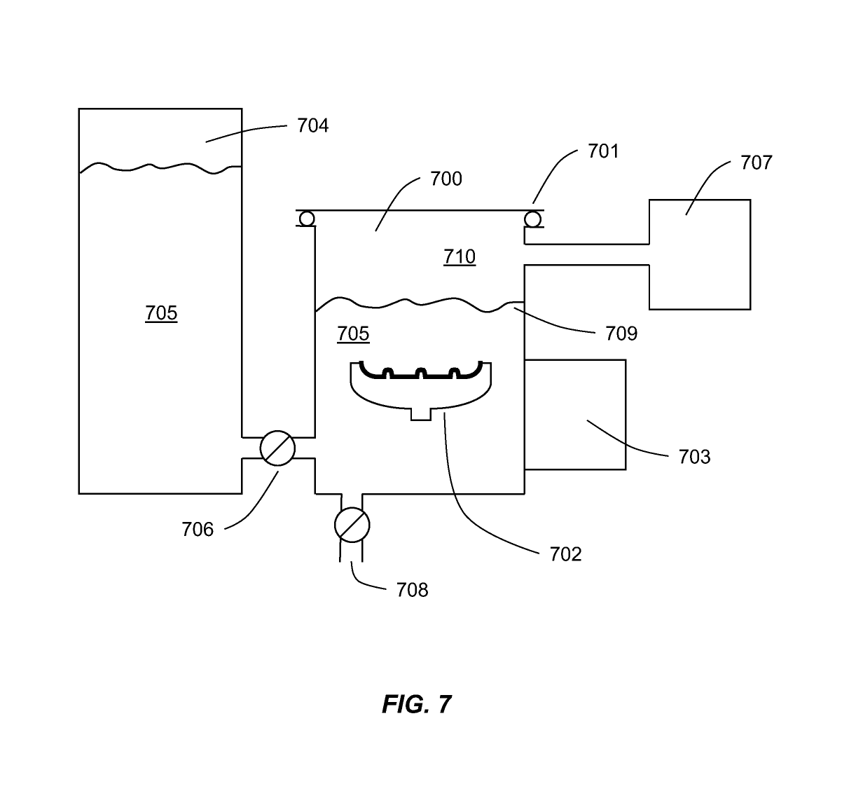

FIG. 7 illustrates a reactor for performing a devulcanization process and a liquid-based particle removal process according to some embodiments. A vulcanization mold 702 that may be contaminated with vulcanized rubber material and possible other process related residues such as sulfur-based residues can be placed inside a reactor 700. A devulcanization process 703, in particular one of a chemical, one of a temperature, one of a pressure, one of an electrical field, and/or one of a radiation induced process can be applied to the contaminated vulcanization mold 702 to break the sulfur-bonds of the contamination material. After at least one cycle of a devulcanization process 703, the reactor 700 can be filled with a process liquid 705. The process liquid 705 can be stored in a separate tank 704, which can be connected to the reactor 700 with a valve 706. The reactor 700 can be filled with at least so much process liquid 705 that the mold 702 may be fully submerged in the process liquid 705. The reactor 700 can be closed with a pressure resistant airtight cover 701 to separate the inner part of the reactor 700 from the ambient environment. The filling level 709 of the process liquid 705 inside the reactor 700 can be in such way that there may be a gas entrapped space 710 between the filling level 709 of the process liquid 705 and the cover 701 of the reactor 700. A liquid-based particle removal process 707 can be applied, the process being one of a flushing, one of a liquid motion, one of a cavitation or one of a nucleation. A second valve 708 can be opened to facilitate one of a flushing or one of a liquid motion. A flushing can be executed in cyclic bursts.

In a preferred embodiment of the present invention a vulcanization mold 702 that may be contaminated with vulcanized rubber material and possibly other process related residues such as sulfur-based residues may be placed inside a reactor 700. A devulcanization process 703, in particular one of a chemical, one of a temperature, one of a pressure, one of an electrical field, and/or one of a radiation induced process may be applied to the contaminated vulcanization mold 702 to break the sulfur-bonds of the contamination material. After at least one cycle of a devulcanization process 703, the reactor 700 may be filled with a process liquid 705. The process liquid 705 can be stored in a separate tank 704, which can be connected to the reactor 700 with a valve 706. The reactor 700 may be filled with at least so much process liquid 705 that the vulcanization mold 702 may be fully submerged in the process liquid 705. The reactor 700 may be closed with a pressure resistant airtight cover 701 to separate the inner part of the reactor 700 from the ambient environment. The filling level 709 of the process liquid 705 inside the reactor 700 may be chosen in such way that there may be a gas entrapped space 710 between the filling level 709 of the process liquid 705 and the cover 701 of the reactor 700. A liquid-based particle removal process 707 may be applied, the process characterized in that the state of the process liquid 705 and/or the gas inside the gas entrapped space 710 may be changed in a cyclic manner, wherein the pressure of the gas may be decreased and increased cyclically, or wherein the volume of the gas entrapped space 710 may be decreased and increased cyclically. This cyclical process can create an effect that can cause the process liquid to excavate or otherwise remove the contaminants from inside the mold.

It is noted that the process liquid can return to the holding tank directly, wherein the process liquid can suspend the material removed. Since the process liquid is able to suspend the removed material, it can be reused until it is needed to be cleaned or replaced. In other embodiments, the holding tank, or an inline filter or other removal system can be in use. This can include filter units that passively or actively remove the suspended contaminants or may for instance be in the tank, wherein steeling or other passive or active systems may clean the process fluid.

In order to efficiently remove all relevant contamination from a vulcanization mold surface and from vulcanization mold cavities, such as an air venting system, it can be required to apply multiple alternating devulcanization and liquid-based particle removal cycles.

FIG. 8A-8F illustrate a devulcanization process and liquid-based particle removal process according to some embodiments.

FIG. 8A illustrates a detailed view of a mold 800 with an air venting system. The mold having both a surface contamination 801 and an air venting system contamination 802 consisting of vulcanized rubber material and possibly other process related residues such as sulfur-based residues.

FIG. 8B illustrates a first cycle of a devulcanization process in which solid vulcanized rubber contamination can be turned into its base substances on a particle level by reversing the vulcanization and breaking the sulfur-bonds of the contamination. A first devulcanization cycle can be able to penetrate and devulcanize a first portion 811 of the contamination. A remaining portion 812 of the contamination can be still vulcanized. Such remaining portion 812 can for example be present inside an air venting system.

FIG. 8C illustrates a liquid-based particle removal process. The removal process can be applied to remove a devulcanized portion 821 from the mold 820 in order to expose a remaining portion 822 of the contamination for a consecutive operation.

FIG. 8D illustrates an exposed remaining portion 832 of the contamination of the mold 830.

FIG. 8E illustrates a second cycle of a devulcanization process in which solid vulcanized rubber contamination can be turned into its base substances on a particle level by reversing the vulcanization and breaking the sulfur-bonds of the contamination. A second devulcanization or breakdown cycle can be able to penetrate and devulcanize a second portion 842 of the contamination of the mold 840.

FIG. 8F illustrates a liquid-based particle removal process. The removal process can be applied to remove a devulcanized portion 851 from the mold 850. In some embodiments a devulcanization process and a liquid-based particle removal process can be repeated in an alternating manner until the contamination has been completely removed from the vulcanization mold.

In some embodiments of the present invention, a method and a system may be disclosed that enables cleaning of vulcanization molds, for example of tire molds, by exposing such molds to a devulcanization process and to a liquid-based particle removal process.

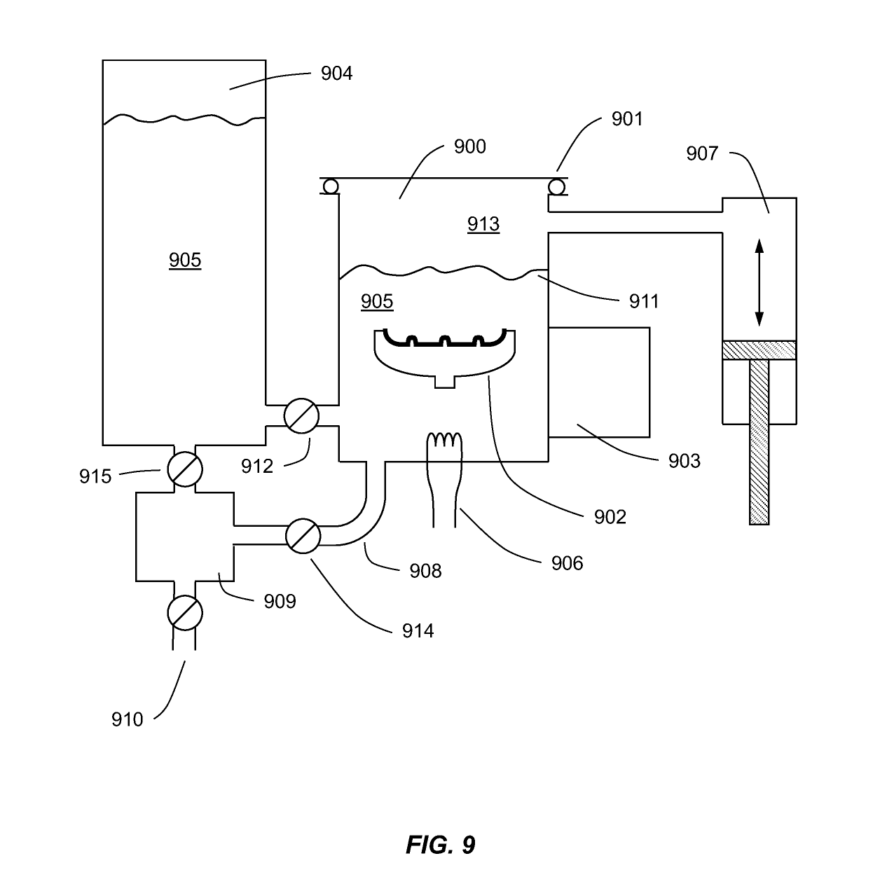

FIG. 9 illustrates a preferred method and a preferred system according to some embodiments of the present invention. A vulcanization mold 902 that may be contaminated with vulcanized rubber material and possibly other process related residues such as sulfur-based residues may be placed inside a reactor 900. A devulcanization process 903, in particular one of a chemical, one of a temperature, one of a pressure, one of an electrical field, and/or one of a radiation induced process may be applied to the contaminated vulcanization mold 902 to break the sulfur-bonds of the contamination material. After at least one cycle of a devulcanization process 903, the reactor 900 may be filled with a process liquid 905. The process liquid 905 can be stored in a separate storage tank 904, which can be connected to the reactor 900 with a first valve 912. The reactor 900 may be filled with at least so much process liquid 905 that the vulcanization mold 902 may be fully submerged in the process liquid 905. The reactor 900 may be closed with a pressure resistant airtight cover 901 to separate the inner part of the reactor 900 from the ambient environment. The filling level 911 of the process liquid 905 inside the reactor 900 may be chosen in such way that there may be a gas entrapped space 913 between the filling level 911 of the process liquid 905 and the cover 901 of the reactor 900. After the filling process the first valve 912 may be closed again. The process liquid 905 inside the reactor 900 can be brought to a defined temperature by a temperature transfer element 906. A liquid-based particle removal process may be applied, the process characterized in that the state of the process liquid 905 and/or the gas inside the gas entrapped space 913 may be changed in a cyclic manner, wherein the pressure of the gas may be decreased and increased cyclically, or wherein the volume of the gas entrapped space 913 may be decreased and increased cyclically. The volume of the gas entrapped space can for example be decreased and increased by a piston 907 that may be connected to the gas entrapped space 913 of the reactor 900.

This process can include a nucleation process wherein the decreasing and increasing the pressure of the gas inside the gas entrapped space 913 cyclically, or decreasing and increasing the volume of the gas entrapped space 913 cyclically can cause gas bubbles inside the process liquid, on the vulcanization mold and also inside the cavities of the vulcanization mold. These gas bubbles can implode during each pressure changing cycle or during each volume changing cycle, resulting in both a kinetic impact on the devulcanized particles as well as a liquid motion upon implosion of the gas bubbles and thus also small cavities such as an air venting system of a mold can be reached efficiently.

After at least one liquid-based particle removal operation, a second valve 914 can be opened to release the process liquid 905 in which now devulcanized particles are present into a filtration system 909. After all process liquid may be released from the reactor 900 into the filtration system 909, the second valve 914 can be closed. A filtration process can be performed by the filtration system 909 to separate the contamination particles and substances from the process liquid 905. After a filtration process, a third valve 915 can be opened and the filtered process liquid 905 can be filled back into the storage tank 904 of the process liquid 905.

Additionally a separate outlet 910 of the filtration system 909 can be opened to release the contamination residue from the filtration system 909. A devulcanization process 903 and a liquid-based particle removal process can be performed in an alternating manner at least one time.

In some embodiments of the present invention, a method and a system may be disclosed that enables cleaning of molds or vulcanization molds, for example of tire molds, by exposing such molds to a devulcanization process, to a liquid-based particle removal process and to a drying process.

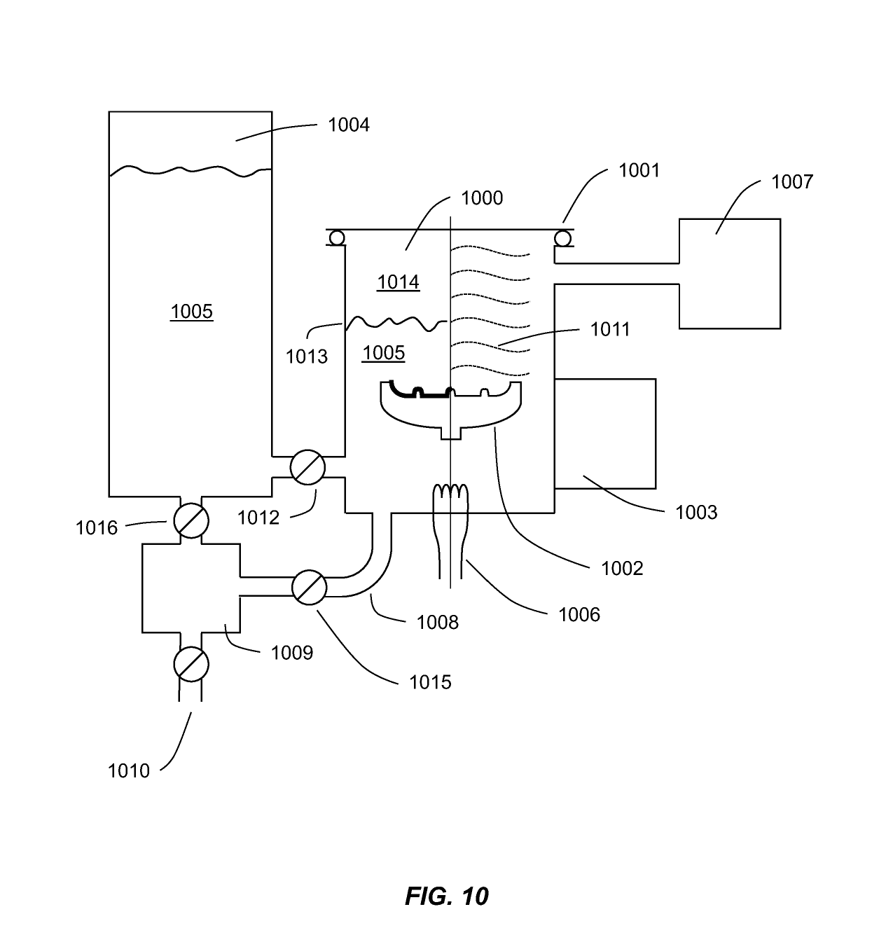

FIG. 10 illustrates a preferred method and a preferred system according to some embodiments of the present invention. A vulcanization mold 1002 that may be contaminated with vulcanized rubber material and possibly other process related residues such as sulfur-based residues may be placed inside a reactor 1000. A devulcanization process 1003, in particular one of a chemical, one of a temperature, one of a pressure, one of an electrical field, and/or one of a radiation induced process may be applied to the contaminated vulcanization mold 1002 to break the sulfur-bonds of the contamination material. After at least one cycle of a devulcanization process 1003, the reactor 1000 may be filled with a process liquid 1005. The process liquid 1005 can be stored in a separate storage tank 1004, which can be connected to the reactor 1000 with a first valve 1012. The reactor 1000 may be filled with at least so much process liquid 1005 that the vulcanization mold 1002 may be fully submerged in the process liquid 1005. The reactor 1000 may be closed with a pressure resistant airtight cover 1001 to separate the inner part of the reactor 1000 from the ambient environment. The filling level 1013 of the process liquid 1005 inside the reactor 1000 may be chosen in such way that there may be a gas entrapped space 1014 between the filling level 1013 of the process liquid 1005 and the cover 1001 of the reactor 1000. After the filling process the first valve 1012 may be closed again. The process liquid 1005 inside the reactor 1000 can be brought to a defined temperature by a temperature transfer element 1006.

A liquid-based particle removal process may be applied, the process characterized in that the state of the process liquid 1005 and/or the gas inside the gas entrapped space 1014 may be changed in a cyclic manner, wherein the pressure of the gas may be decreased and increased cyclically, or wherein the volume of the gas entrapped space 1014 may be decreased and increased cyclically. The pressure of the gas inside the gas entrapped space can for example be decreased and increased by a vacuum pump 1007 that may be connected to the gas entrapped space 1014 of the reactor 1000.

Decreasing and increasing the pressure of the gas inside the gas entrapped space 1014 cyclically, or decreasing and increasing the volume of the gas entrapped space 1014 cyclically can cause gas bubbles inside the process liquid, on the vulcanization mold and also inside the cavities of the vulcanization mold. These gas bubbles can implode during each pressure changing cycle or during each volume changing cycle, resulting in both a kinetic impact on the devulcanized particles as well as a liquid motion upon implosion of the gas bubbles and thus also small cavities such as an air venting system of a mold can be reached efficiently. After at least one liquid-based particle removal operation, a second valve 1015 can be opened to release the process liquid 1005 in which now devulcanized particles are present into a filtration system 1009. After all process liquid may be released from the reactor 1000 into the filtration system 1009, the second valve 1015 can be closed.

A filtration process can be performed by the filtration system 1009 to separate the contamination particles and substances from the process liquid 1005. After a filtration process, a third valve 1016 can be opened and the filtered process liquid 1005 can be filled back into the storage tank 1004 of the process liquid 1005. Additionally a separate outlet 1010 of the filtration system 1009 can be opened to release the contamination residue from the filtration system 1009. After performing a devulcanization process 1003 and a liquid-based particle removal process in an alternating manner at least one time, the vulcanization mold can be exposed to a drying process within the same reactor 1000. For this purpose, the reactor 1000 may be filled again with a process liquid 1005. The process liquid 1005 can be stored in a separate storage tank 1004, which can be connected to the reactor 1000 with a first valve 1012. The reactor 1000 may be filled with at least so much process liquid 1005 that the vulcanization mold 1002 may be fully submerged in the process liquid 1005. The reactor 1000 remains closed with a pressure resistant airtight cover 1001 to separate the inner part of the reactor 1000 from the ambient environment. The filling level 1013 of the process liquid 1005 inside the reactor 1000 may be chosen in such way that there may be a gas entrapped space 1014 between the filling level 1013 of the process liquid 1005 and the cover 1001 of the reactor 1000. After the filling process the first valve 1012 may be closed again.

Alternatively, another process liquid with other properties can be used by using a second tank, a second series of valves and a second filtration system (not shown in FIG. 10). The process liquid 1005 inside the reactor 1000 can be brought to a defined temperature by a temperature transfer element 1006. Typically, the process liquid 1005 may be brought to a high temperature in order to heat up the vulcanization mold 1002 as much as possible. Once the process liquid 1005 and the vulcanization mold 1002 have reached the desired temperature, a second valve 1015 can be opened to release the process liquid 1005 into a filtration system 1009. After all process liquid may be released from the reactor 1000 into the filtration system 1009, the second valve 1015 can be closed.

A filtration process can be performed by the filtration system 1009 to separate any remaining contamination particles and substances from the process liquid 1005. After a filtration process, a third valve 1016 can be opened and the filtered process liquid 1005 can be filled back into the storage tank 1004 of the process liquid 1005. Additionally, a separate outlet 1010 of the filtration system 1009 can be opened to release the contamination residue from the filtration system 1009. After the process liquid 1005 has been removed from the reactor 1000, the hot vulcanization mold 1002 remains present in a hot gas entrapped space 1014. Additionally, a thin layer of residual process liquid 1005 can remain on the surface and inside the cavities such as the air venting system of the vulcanization mold 1002. The residual process liquid can now be evaporated by cyclically decreasing and increasing the pressure of the gas inside the gas entrapped space 1014 inside the reactor 1000. In this case for example a vacuum pump represented by part 1007 can be connected to the gas entrapped space 1014 of the reactor. The residual process liquid can also be evaporated by cyclically decreasing and increasing the volume of the gas entrapped space 1014 inside the reactor 1000. In this case a for example a piston, represented by part 1007 can be connected to the gas entrapped space 1014 of the reactor. In a preferred embodiment of the invention the decrease and increase of a gas pressure and the decrease and increase of a gas entrapped space volume are performed quickly and abruptly to create a strong vaporization reaction in which vaporized process liquid 1011 leaves the surface and the cavities of the vulcanization mold 1002 with a high kinetic energy, which can effectively dry the mold 1002 and also evacuate last remaining particles from the mold 1002. After performing a devulcanization process 1003 and a liquid-based particle removal process in an alternating manner at least one time, the vulcanization mold can be exposed to a drying process within the same reactor 1000 at least once.

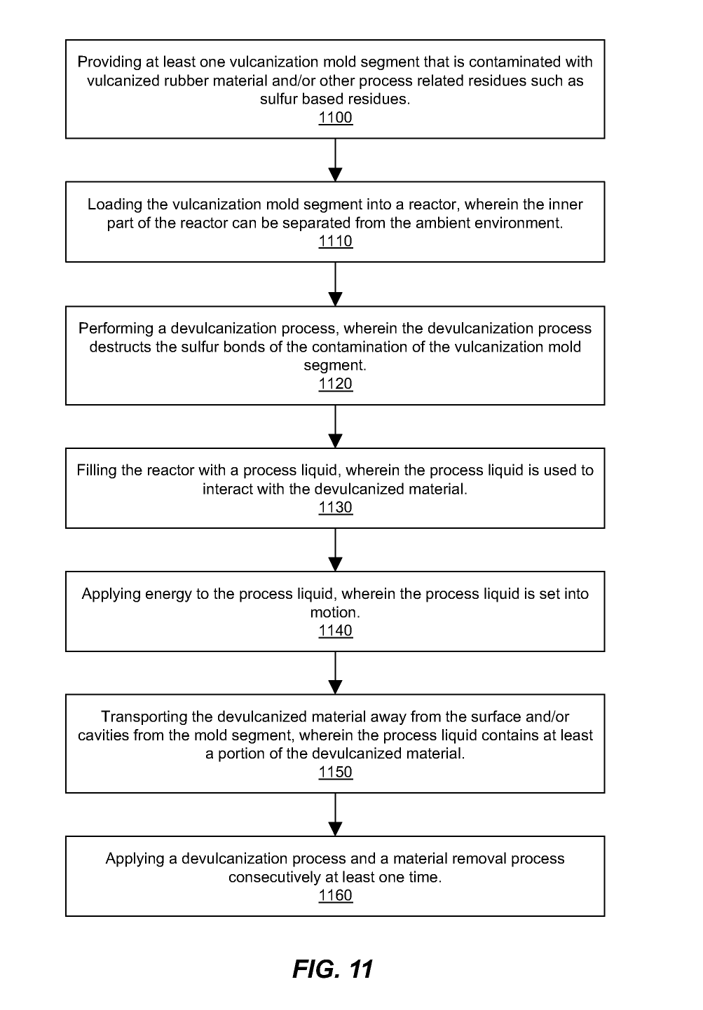

FIG. 11 illustrates a flow chart for operating a vulcanization mold cleaning process according to some embodiments. Operation 1100 provides at least one vulcanization mold segment that may be contaminated with vulcanized rubber material and/or other process related residues such as sulfur based residues. In operation 1110 the vulcanization mold segment may be loaded into a reactor, wherein the inner part of the reactor can be separated from the ambient environment. Operation 1120 performs a devulcanization process, wherein the devulcanization process destructs the sulfur bonds of the contamination of the vulcanization mold segment. In operation 1130 the reactor may be filled with a process liquid, wherein the process liquid may be used to interact with the devulcanized material.

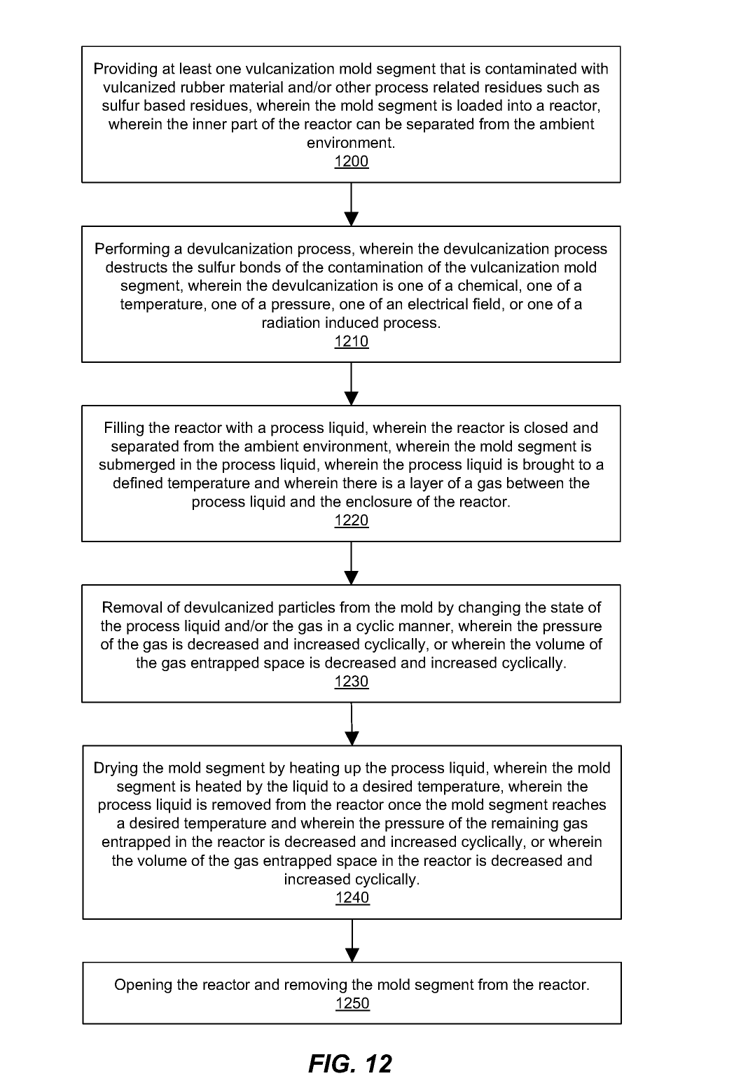

Operation 1140 applies energy to the process liquid, wherein the process liquid may be set into motion. In operation 1150 the devulcanized material may be transported away from the surface and/or cavities from the mold segment, wherein the process liquid contains at least a portion of the devulcanized material. Operation 1160 applies a devulcanization process and a material removal process consecutively at least one time. FIG. 12 illustrates a flow chart for operating a vulcanization mold cleaning and drying process according to some embodiments. Operation 1200 provides at least one vulcanization mold segment that may be contaminated with vulcanized rubber material and/or other process related residues such as sulfur based residues, wherein the mold segment may be loaded into a reactor, wherein the inner part of the reactor can be separated from the ambient environment. In operation 1210 a devulcanization process may be performed, wherein the devulcanization process destructs the sulfur bonds of the contamination of the vulcanization mold segment, wherein the devulcanization may be one of a chemical, one of a temperature, one of a pressure, one of an electrical field, or one of a radiation induced process. Operation 1220 fills the reactor with a process liquid, wherein the reactor may be closed and separated from the ambient environment, wherein the mold segment may be submerged in the process liquid, wherein the process liquid may be brought to a defined temperature and wherein there may be a layer of a gas between the process liquid and the enclosure of the reactor. In operation 1230 devulcanized particles are removed from the mold by changing the state of the process liquid and/or the gas in a cyclic manner, wherein the pressure of the gas may be decreased and increased cyclically, or wherein the volume of the gas entrapped space may be decreased and increased cyclically. Operation 1240 dries the mold segment by heating up the process liquid, wherein the mold segment may be heated by the liquid to a desired temperature, wherein the process liquid may be removed from the reactor once the mold segment reaches a desired temperature and wherein the pressure of the remaining gas entrapped in the reactor may be decreased and increased cyclically, or wherein the volume of the gas entrapped space in the reactor may be decreased and increased cyclically. In operation 1250 the reactor may be opened and the mold segment may be removed from the reactor.

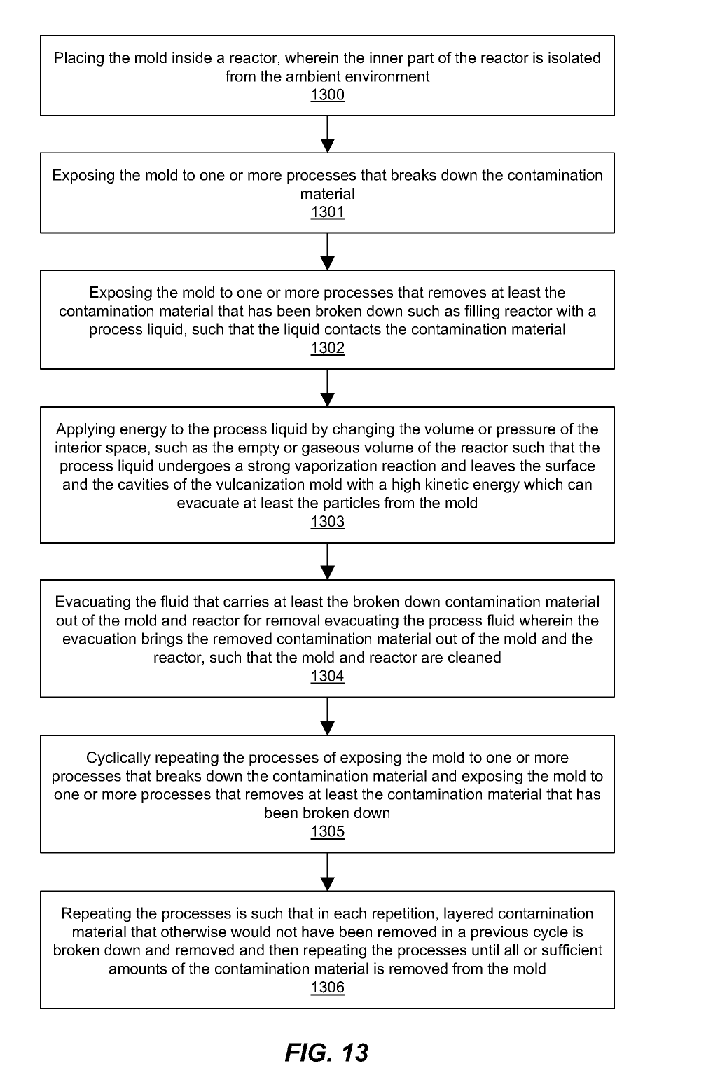

FIG. 13 illustrates a flow chart for operating a vulcanization mold cleaning and drying process according to some embodiments.

FIG. 13 describes at least Operation 1300 wherein includes at least placing the mold inside a reactor, wherein the inner part of the reactor is isolated from the ambient environment, Operation 1301 wherein includes at least exposing the mold to one or more processes that breaks down the contamination material, Operation 1302 wherein includes at least exposing the mold to one or more processes that removes at least the contamination material that has been broken down such as filling reactor with a process liquid, such that the liquid contacts the contamination material, Operation 1303 wherein includes at least applying energy to the process liquid by changing the volume or pressure of the interior space, such as the empty or gaseous volume of the reactor such that the process liquid undergoes a strong vaporization reaction and leaves the surface and the cavities of the vulcanization mold with a high kinetic energy which can evacuate at least the particles from the mold, Operation 1304 wherein includes at least evacuating the fluid that carries at least the broken down contamination material out of the mold and reactor for removal evacuating the process fluid wherein the evacuation brings the removed contamination material out of the mold and the reactor, such that the mold and reactor are cleaned, Operation 1305 wherein includes at least cyclically repeating the processes of exposing the mold to one or more processes that breaks down the contamination material and exposing the mold to one or more processes that removes at least the contamination material that has been broken down, and Operation 1306 wherein includes at least repeating the processes is such that in each repetition, layered contamination material that otherwise would not have been removed in a previous cycle is broken down and removed and then repeating the processes until all or sufficient amounts of the contamination material is removed from the mold.

It is noted that in any of the embodiments, that the nucleation and cleaning steps after devulcanization is optional, wherein any combination of processes may be applied, since the devulcanization process may be enough to clean the mold, and wherein just this application of devulcanization to the mold is unique over any other prior arts. It is then noted in addition the nucleation process and cyclical process can additionally applied to this primary process of devulcanization any material in the mold and removing the material.

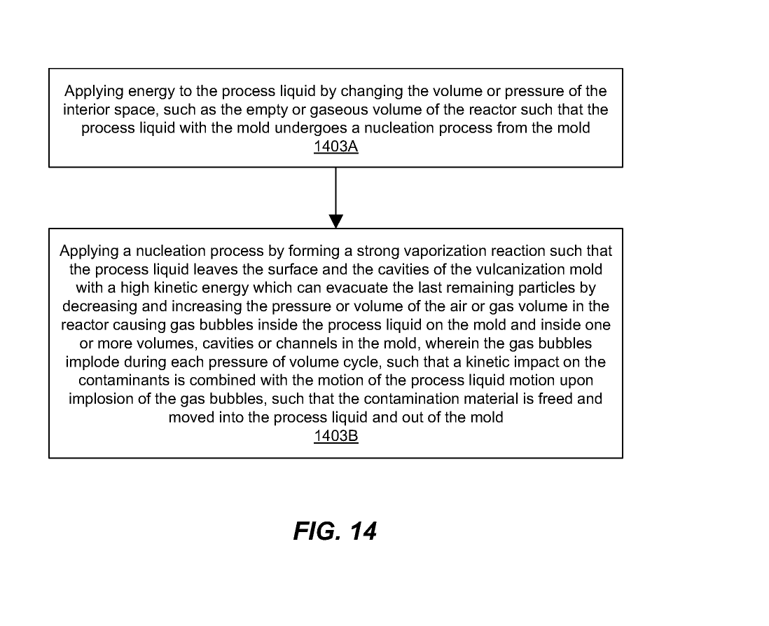

FIG. 14 illustrates a flow chart for operating a vulcanization mold cleaning and drying process according to some embodiments, wherein it is noted that Operation 1403A and Operation 1404B are alternative embodiments for or in addition to Operation 1304 in FIG. 13.

Thus, Operation 1403A wherein includes at applying energy to the process liquid by changing the volume or pressure of the interior space, such as the empty or gaseous volume of the reactor such that the process liquid with the mold undergoes a nucleation process from the mold and Operation 1403B includes at least applying a nucleation process by forming a strong vaporization reaction such that the process liquid leaves the surface and the cavities of the vulcanization mold with a high kinetic energy which can evacuate the last remaining particles by decreasing and increasing the pressure or volume of the air or gas volume in the reactor causing gas bubbles inside the process liquid on the mold and inside one or more volumes, cavities or channels in the mold, wherein the gas bubbles implode during each pressure or volume cycle, such that a kinetic impact on the contaminants is combined with the motion of the process liquid motion upon implosion of the gas bubbles, such that the contamination material is freed and moved into the process liquid and out of the mold.

It is noted that the operations as noted in this application can be combined in any order, in place of one another can be of any plurality, repetition, cycle or order.

Although the present embodiments have been described with reference to specific example embodiments, it will be evident that various modifications and changes may be made to these embodiments without departing from the broader spirit and scope of the various embodiments. It should be understood by one of ordinary skill in the art that the terms describing processes, products, elements, or methods are industry terms and may refer to similar alternatives In addition, the components shown in the figures, their connections, couples, and relationships, and their functions, are meant to be exemplary only, and are not meant to limit the embodiments described herein.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system) and of which may be in any form including transitory, non-transitory or persistent data systems, as well as may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method for cleaning a mold that is contaminated with a contamination material, wherein
the mold is one or more molds or mold segments, and wherein the method includes at least:
placing the mold inside a reactor, wherein the inner part of the reactor is isolated from the ambient environment;
exposing the mold to one or more processes that breaks down the contamination material;
exposing the mold to one or more processes that removes at least the contamination material that has been broken down.

2. A method as is claim 1, wherein:
the mold includes volumes, cavities and channels which are easily, or through use, deposited with the contamination material.

3. A method, as in claim 1, wherein:
the mold is a mold for making tires.

4. A method as is claim 1, wherein:
the mold is for vulcanization molding and the contamination material is vulcanized rubber.

5. A method as is claim 1, wherein:
the contamination material is vulcanization residues including sulfur based residues.

6. A method as is claim 1, wherein:
the contamination material is at least in the mold venting system.

7. A method as is claim 1, wherein:
the process that breaks down the contamination material is a devulcanization process including at least one of the following processes: chemical, temperature, pressure, electrical field, or radiation.

8. A method as in claim 7, wherein
the processes that breaks down the contamination material is a process including at least: destructing sulfur-bonds in the contamination material which turns the vulcanized rubber contamination into base substances on a particle level.

9. A method as in claim 1, wherein
the processes that removes at least the contamination material that has been broken down includes at least:
filling and then evacuating the reactor with a process liquid, such that the liquid contacts the contamination material and carries at least the broken down contamination material out of the mold and reactor for removal.

10. A method as in claim 9, wherein:
applying energy to the process liquid.

11. A method as in claim 10, wherein:
the energy applied is such that the process liquid undergoes a strong vaporization reaction and leaves the surface and the cavities of the vulcanization mold with a high kinetic energy which can evacuate particles from the mold.

12. A method as is claim 9, wherein:
filling the reactor includes submerging the mold, wherein there is a layer of a gas between the process liquid and the enclosure of the reactor.

13. A method as is claim 12, wherein:
the pressure of the gas is decreased and increased cyclically.

14. A method as is claim 12, wherein:
the volume of the gas entrapped space is decreased and increased.

15. A method as in claim 9, wherein:
evacuating the process fluid wherein the evacuation brings the removed contamination material out of the mold and the reactor, such that the mold and reactor are cleaned.

16. A method as in claim 11, wherein
the strong vaporization can also effectively dry the mold.

17. A method as in claim 12, wherein:
the process includes the steps for a nucleation process, wherein includes at least:
decreasing and increasing the pressure or volume of a gas causing gas bubbles inside the process liquid on the mold and inside one or more volumes, cavities or channels in the mold, wherein the gas bubbles implode during each pressure or volume cycle, such that a kinetic impact on the contaminants is combined with the motion of the process liquid motion upon implosion of the gas bubbles, such that the contamination material is freed and moved into the process liquid and out of the mold.

18. A method as in clam 1, wherein:
cyclically repeating the processes of exposing the mold to one or more processes that breaks down the contamination material and exposing the mold to one or more processes that removes at least the contamination material that has been broken down.

19. A method as in claim 18, wherein:
repeating the processes is such that in each repetition, layered contamination material that otherwise would not have been removed in a previous cycle is broken down and removed.

20. A method as in claim 18, wherein:
repeating the processes until all or sufficient amounts of the contamination material is removed from the mold.
